(19) United States
(12) Patent Application Publication
(10) Pub. No.: US 2020/0379867 A1
(43) Pub. Date: Dec. 3, 2020

(54) ANOMALOUS COMPUTING RESOURCE USAGE DETECTION BASED ON SEASONALITY-BASED DYNAMIC THRESHOLDS

(71) Applicant: Microsoft Technology Licensing, LLC, Redmond, WA (US)

(72) Inventors: Rachel Lemberg, Herzliya (IL); Adi Eldar, Kiryat-Ono (IL); Liad Tal Rothschild, Givatayim (IL); Yaniv Lavi, Tel Aviv-Yafo (IL); Josef Gal, Kiryat-Ono (IL); Matitiyahu Gabriel Nissinmann, Ramat Gan (IL)

(21) Appl. No.: 16/428,289

(22) Filed: May 31, 2019

(51) Int. Cl. G06F 11/34; G06F 17/18; G06F 17/14; G06F 11/32; G06F 16/22

(52) U.S. Cl. CPC G06F 11/3452; G06F 17/18; G06F 17/142; G06F 11/324; G06F 16/2228; G06F 17/14

(57) ABSTRACT

Embodiments are configured to provide dynamic thresholds for alerting users of anomalous resource usage of computing resources. The dynamic thresholds may be based on the historical behavior of compute metrics (or a time series obtained therefor) associated with the computing resources and a detected seasonality in that time series. The seasonality is detected based on an analysis of several, different time series combinations that are based on the original time series, which advantageously increases the probability of successful seasonality detection. Based on characteristics of the time series, a model for generating dynamic thresholds may be determined. The dynamic thresholds track the detected seasonality of the computing metrics, rather than being a static threshold. As utilization of the computing resources continues, the determined thresholds are applied to the compute metrics. If the determined thresholds are exceeded, an alert indicating an anomalous resource usage may be provided to a user.

### BACKGROUND

Metric alert rules are used to proactively detect service problems. Many of today's alerts are applied on various metrics generated by a service and rely on threshold values that are manually defined. An effective alert rule alerts when the metric does not behave as expected, while on the other hand, should not create too many false positives. Configuring static thresholds is a complex task, requiring the service owner to learn the historical behavior of each metric, apply some of his deep domain knowledge of the service, and make a prediction of what value ranges should be considered within the norm. The challenge scales up when a metric has one or more dimensions slicing it to multiple time series with different normal behaviors. In the dynamic environment in which modern services operate, services undergo frequent updates, and there are frequent changes to the way services are consumed. This requires an ongoing adjustment of static thresholds which means repeating the complex task every time a change happens.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are configured to provide dynamic thresholds for alerting users of anomalous resource usage of computing resources. The dynamic thresholds may be based on the historical behavior of compute metrics (or a time series obtained therefor) associated with the computing resources and a detected seasonality in that time series. The seasonality is detected based on an analysis of several, different time series combinations that are based on the original time series, which advantageously increases the probability of successful seasonality detection. Based on characteristics of the time series metric, a model for generating dynamic thresholds may be determined. The dynamic thresholds track the detected seasonality of the compute metrics, rather than being a static (or straight-line) threshold. As utilization of the computing resources continues, the determined thresholds are applied to the compute metrics. If the determined thresholds are exceeded, an alert indicating an anomalous resource usage (which may be indicative of an issue with respect to the computing resource(s)) may be provided to a user.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of an example network-based computing system configured to dynamically determine a threshold for alerting users of anomalous resource usage.

FIG. 2 is a block diagram of a system for determining a seasonal pattern in a time series for a particular metric in accordance with an embodiment.

FIG. 3 shows a flowchart of a method for determining a seasonal pattern in a time series in accordance with an example embodiment.

FIG. 4 is a block diagram of a system for determining a model for generating dynamic thresholds for a particular metric in accordance with an embodiment.

FIG. 5 shows a flowchart of a method for selecting a modeler for generating dynamic thresholds in accordance with an example embodiment.

FIG. 6 is a block diagram of a seasonal adjusted boxplot-based modeler in accordance with an example embodiment.

FIG. 7 shows a graph depicting a seasonal pattern in accordance with an example embodiment.

FIG. 8 depicts a graph showing a minimum threshold and a maximum threshold generated based on a seasonal pattern in accordance with an example embodiment.

FIG. 9 shows a flowchart of a method for generating dynamic thresholds using a seasonal adjusted boxplot-based modeler in accordance with an example embodiment.

FIG. 10 is a block diagram of a Box-Cox transformation-based modeler in accordance with an example embodiment.

FIG. 11A depicts a graph that shows a time series and a seasonal pattern in accordance with an example embodiment.

FIG. 11B depicts a graph that shows residual data obtained as a result of a seasonal pattern being removed from a time series in accordance with an example embodiment.

FIG. 11C depicts a graph showing transformed residual data in accordance with an example embodiment.

FIG. 12 shows a flowchart of a method for generating dynamic thresholds using a Box-Cox transformation-based modeler in accordance with an example embodiment.

FIG. 13 shows a flowchart of a method for issuing alerts indicative of anomalous resource usage based on dynamic thresholds in accordance with an example embodiment.

FIG. 14 is a block diagram of a dynamic threshold-based alert engine in accordance with an embodiment.

FIG. 15 is a block diagram of an example processor-based computer system that may be used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner

### II. Example Implementations

Embodiments described herein provide dynamic thresholds for alerting users of anomalous resource usage of computing resources. The dynamic thresholds may be based on the historical behavior of compute metrics (or a time series obtained therefor) associated with the computing resources and a detected seasonality in that time series. The seasonality is detected based on an analysis of several, different time series combinations that are based on the original time series, which advantageously increases the probability of successful seasonality detection. Based on characteristics of the time series, a model for generating dynamic thresholds may be determined. The dynamic thresholds track the detected seasonality of the compute metrics, rather than being a static (or straight-line) threshold. As utilization of the computing resources continue, the determined thresholds are applied to the compute metrics. If the determined thresholds are exceeded, an alert indicating an anomalous resource usage (which may be indicative of an issue with respect to the computing resource(s)) may be provided to a user.

The foregoing techniques advantageously enable the automatic detection of seasonal behavior and automatically set the thresholds such that an alert will be triggered only on deviation from the expected seasonal behavior. For example, alerts based on dynamic thresholds will not be triggered if a service is regularly idle on the weekends and then spikes every Monday. The techniques described herein recognize this seasonality and generate the dynamic thresholds based thereon. Static thresholds, on the other hand, are not very effective for such seasonal metrics. Instead, static thresholds issue alerts during spikes caused by seasonal behaviors, and as a result, unnecessary diagnostics are performed on the associated compute resource. This in turn causes significant downtime with respect to the compute resource. Accordingly, the techniques described herein improve the functionality of a system in which such compute resources are included, as any issues with the compute resources are accurately detected (and thus resolvable), while also avoiding unnecessary downtime due from false positives.

Moreover, the embodiments described herein improve the functioning of the computing devices for which the metrics are being obtained. For instance, conventional techniques that utilize static thresholds may mask legitimate issues. For instance, if the static threshold is set large enough to accommodate a large seasonal spike, then anomalous behaviors may go undetected. As such, a user may never be alerted when such a behavior occurs and subsequently remedy the issue. This may have a detrimental effect on the computing device. For instance, the computing device may be suffering from abnormal memory usage and/or network usage, which would go unnoticed by the user. Accordingly, the computing device may operate much more slowly and/or may be unable to properly handle requests. In contrast, because the embodiments described herein dynamically track metrics based on their seasonality, such a situation is avoided.

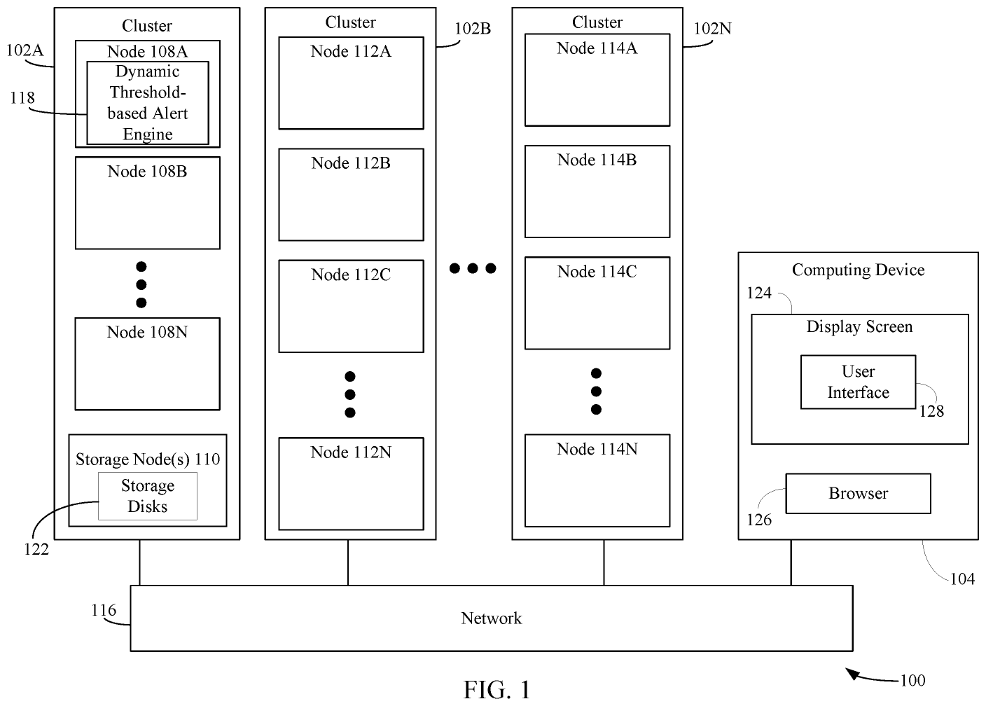

For example, FIG. 1 shows a block diagram of an example network-based computing system 100 configured to dynamically determine a threshold for alerting users of anomalous resource usage, according to an example embodiment. As shown in FIG. 1, system 100 includes a plurality of clusters 102A, 102B and 102N. A computing device 104 is communicatively coupled with system 100 via a network 116. Furthermore, each of clusters 102A, 102B and 102N are communicatively coupled to each other via network 116, as well as being communicatively coupled with computing device 104 through network 116. Network 116 may comprise one or more networks such as local area networks (LANs), wide area networks (WANs), enterprise networks, the Internet, etc., and may include one or more of wired and/or wireless portions.

Clusters 102A, 102B and 102N may form a network-accessible server set. Each of clusters 102A, 102B and 102N may comprise a group of one or more nodes and/or a group of one or more storage nodes. For example, as shown in FIG. 1, cluster 102A includes nodes 108A-108N and one or more storage nodes 110, cluster 102B includes nodes 112A-112N, and cluster 102N includes nodes 114A-114N. Each of nodes 108A-108N, 112A-112N and/or 114A-114N are accessible via network 116 (e.g., in a “cloud-based” embodiment) to build, deploy, and manage applications and services. Each of storage node(s) 110 comprises a plurality of physical storage disks 122 that is accessible via network 116 and is configured to store data associated with the applications and services managed by nodes 108A-108N, 112A-112N, and/or 114A-114N.

In an embodiment, one or more of clusters 102A, 102B and 102N may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 102A, 102B and 102N may be a datacenter in a distributed collection of datacenters.

Each of node(s) 108A-108N, 112A-112N and 114A-114N may be configured to execute one or more software applications (or “applications”) and/or services and/or manage hardware resources (e.g., processors, memory, etc.), which may be utilized by users (e.g., customers) of the network-accessible server set. Node(s) 108A-108N, 112A-112N and 114A-114N may also be configured for specific uses. For example, as shown in FIG. 1, node 108A is configured to execute a dynamic threshold-based alert engine 118. It is noted that cluster 102B and/or cluster 102N may also include storage node(s) 110.

Dynamic threshold-based alert engine 118 may be configured to determine dynamic thresholds for alerting users of anomalous resource usage of resources maintained by system 100. For instance, a monitor may obtain metrics associated with resources, such as, but not limited to, operating systems, applications, services executing on one or more of nodes 108A-108N, 112A-112N and/or 114A-114N, hardware and virtual resources maintained by the network-accessible server set (e.g., nodes 108A-108N, 112A-112N and/or 114A-114N, virtual machines, central processor units (CPUs), storage (e.g., storage disks 122), memories, etc.), and/or I/O network bandwidth, power, etc., associated therewith. The metrics may represent numerical data values that describe an aspect of such resources at a particular point of time. For example, the metrics may represent CPU usage, a number of requests issued by a particular application or service, memory or storage utilization, etc. Such metrics may be collected at regular intervals (e.g., each second, each minute, each hour, each day, etc.) and may be aggregated as a time series (i.e., a series of data points indexed in time order). The monitor may collect multiple days or weeks of worth data to obtain the historical behavior of the metric. The time series for each metric may be stored in a storage, such as storage disks 122.

Dynamic threshold-based alert engine 118 may analyze the historical behavior of the metric (i.e., the time series) to determine a seasonal pattern (i.e., a seasonality) therein. A seasonal pattern is a characteristic of the time series in which the data experiences regular or predictable changes that occur at particular time interval, such as hourly, daily, weekly, etc. Examples of seasonal patterns include, but are not limited to, increased network traffic on weekdays than compared to weekends, increased network traffic during business hours than compared to non-business hours, a daily spike in CPU and/or storage utilization (e.g., due to a backup process), etc. The foregoing may be determined by generating several different time series combinations based on the original time series. Additional details regarding determining a seasonal pattern is described below in Subsection A.

The historical time series and/or determined seasonal pattern for a given metric may be utilized by a model selector, which is configured to automatically select a modeler for generating dynamic thresholds with regards to the metric. The model selector may utilize the determined seasonal pattern and/or the diversity of values of the metric to determine which model best fits. Examples of modelers include, but are not limited to, a low dispersion-based modeler, a seasonal adjusted boxplot-based modeler and a Box-Cox transformation-based modeler. The selected modeler is utilized to determine the dynamic thresholds for the metric. Additional details regarding the model selector is described below in Subsection B.

As the computing resources continue to operate, the monitor continues to obtain computing metrics associated with such resources. The determined thresholds are applied to such computing metrics. If the determined thresholds are exceeded, an alert indicating anomalous resource usage with respect to the computing resource(s) may be provided to a user (e.g., via computing device 104).

A user may access dynamic threshold-based alert engine 118 via computing device 104, for example to enable dynamic threshold generation and/or to receive anomalous resource usage alerts. As shown in FIG. 1, computing device 104 includes a display screen 124 and a browser 126. A user may access dynamic threshold-based alert engine 118 by interacting with an application at computing device 104 capable of accessing dynamic threshold-based alert engine 118. For example, the user may use browser 126 to traverse a network address (e.g., a uniform resource locator) to dynamic threshold-based alert engine 118, which invokes a user interface 128 (e.g., a web page) in a browser window rendered on computing device 104. By interacting with the user interface, the user may utilize dynamic threshold-based alert engine 118 to enable dynamic threshold generation and/or to receive anomalous resource usage alerts. Computing device 104 may be any type of stationary or mobile computing device, including a mobile computer or mobile computing device (e.g., a Microsoft ® Surface® device, a laptop computer, a notebook computer, a tablet computer such as an Apple® iPad™, a netbook, etc.), a wearable computing device (e.g., a head-mounted device including smart glasses such as Google® Glass™, etc.), or a stationary computing device such as a desktop computer or PC (personal computer).

A. Seasonal Pattern Detection

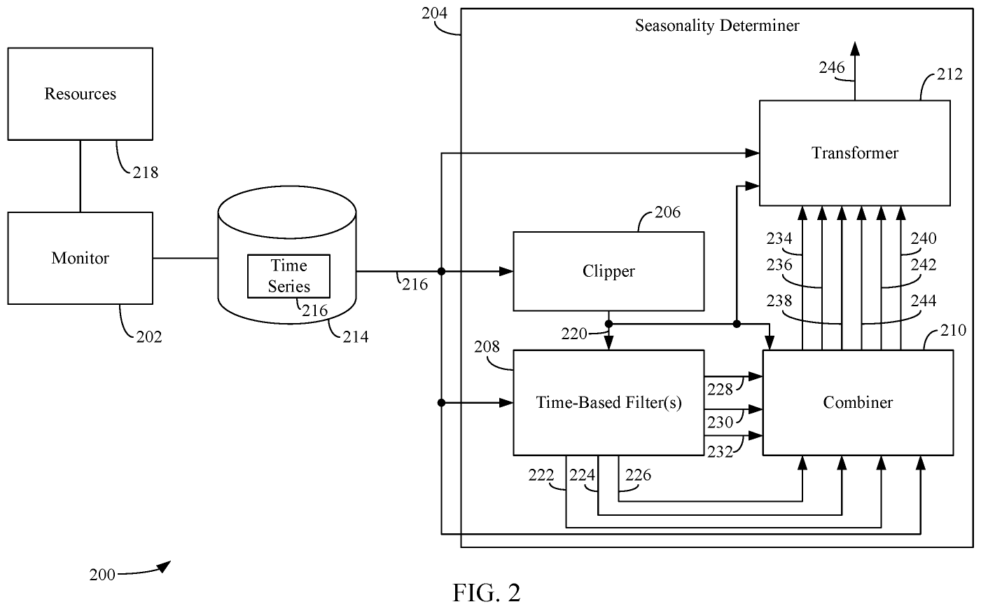

FIG. 2 is a block diagram of a system 200 for determining a seasonal pattern in a time series for a particular metric in accordance with an embodiment. For example, as shown in FIG. 2, system 200 includes a monitor 202, a seasonality detector 204, resources 218, and storage 214. Seasonality detector 204 includes a clipper 206, one or more time filters 208, a combiner 210, and a transformer 212. Each of monitor 202, seasonality detector 204, clipper 206, time filter(s) 208, combiner 210 and transformer 212 may be included in dynamic threshold-based alert engine 118, as described above with reference to FIG. 1.

Monitor 202 may obtain metrics associated with resources 218, such as, but not limited to, operating systems, applications, services executing on one or more of nodes 108A-108N, 112A-112N and/or 114A-114N, hardware and virtual resources maintained by the network-accessible server set (e.g., nodes 108A-108N, 112A-112N and/or 114A-114N, virtual machines, central processor units (CPUs), storage (e.g., storage disks 122), memories, etc.), and/or I/O, network bandwidth, power, etc., associated therewith. Such metrics may be collected at regular intervals and may be aggregated as a time series 216. Monitor 202 may collect multiple days or weeks of worth data to obtain the historical behavior of the metric. The time series for each metric may be stored in storage 214, which may be an example of storage disk(s) 122.

Seasonality detector 204 may be configured to analyze the historical behavior of the metric (i.e., time series 216) to determine a seasonal pattern (i.e., a seasonality) therein. Using known techniques to detect seasonality in a time series is problematic in many real-world scenarios due to noise in the metric that prevents the seasonality from being detected (e.g., by using Fast Fourier Transforms (FFTs)). To overcome this, seasonality detector 204 may generate several different time series combinations that are generated based on the original time series (e.g., time series 216)), which advantageously increases the probability to detect the seasonality. An FFT may be applied to each combination to detect seasonality for each of the generated combinations. The foregoing may be performed using unsupervised machine learning-based techniques, which utilize time series 216 during a training phase in which the seasonal pattern is detected. In accordance with an embodiment, the training phase may be performed approximately every 24 hours. In accordance with such an embodiment, data newly available since the last training phase is added while trailing data is omitted. In accordance with a further embodiment, the history time span used for training may be 10 days, except when weekly seasonality is detected, in which case 28 days of historic span is used. As will be described below, once the seasonal pattern is detected (e.g., via the training phase), dynamic thresholds may be generated based thereon, and the dynamic thresholds may be applied to current compute metrics to detect anomalous behavior. Such techniques may continuously learn a particular metric's behavior and adapts to metric changes. That is, the seasonal pattern and amount of data used for training determined for a particular metric may change over time as the behavior of the metric being monitored changes.

Each time series combination may be generated based on a combination of one or more parameters. The parameter(s) may include, but are not limited to, a clipped (or non-clipped) version of the time series) and/or one or more filtered versions of the non-clipped and/or clipped version of the time series, where the time series are filtered based on different window sizes.

For instance, time series 216 may be clipped by clipper 206. Clipper 206 may be configured to remove outlying data points of time series 216 (e.g., to remove spikes in the metric). For instance, clipper 206 may be configured to remove a certain percentage of the highest and lowest values of time series 216 (e.g., 5% of the highest and lowest values) to generate a clipped time series 220. Each of time series 216 and clipped time series 220 may be provided to time-based filter(s) 208.

Time-based filter(s) 208 may be configured to perform a filtering (or smoothing) function on time series 216 based on different window sizes. The filtering function is configured to reduce the noise in the metric, while preserving the seasonal pattern. The different window sizes may be computed to match the seasonal spans that are frequently recurring in time series 216 (e.g., hourly, daily, weekly, etc.). For instance, time-based filter(s) 208 may generate a first filtered time series 222 based on time series 216 in accordance with a first window size (e.g., hourly). In particular, time-based filter(s) 208 may generate first filtered time series 222 by performing a filtering function on time series 216 that, for each data point in time series 216, combines adjacent data points with the data point to determine an average value. The average values are used to generate first filtered time series 222. Time-based filter(s) 208 may generate a second filtered time series 224 and a third filtered time series 226 based on time series 216 in accordance with a second window size (e.g., daily) and a third window size (e.g., weekly), respectively, in a similar manner as described with reference to first filtered time series 222 However, when generating second filtered time series 224, time-based filter(s) 208 may combine adjacent points for a given data point that are further in vicinity than the adjacent data points utilized to generate first filtered time series 222. Similarly, when generating third filtered time series 226, time-based filter(s) 208 may combine adjacent points for a given data point that are further in vicinity than the adjacent data points utilized to generate second filtered time series 224.

Time-based filter(s) 228 may also be configured to perform a filtering function on clipped time series 220 based on different window sizes in a similar manner as described above. For instance, as shown in FIG. 2, time-based filter(s) 208 may generate a first filtered, clipped time series 228 for a first window size (e.g., hourly) based on a filtering function that, for each data point in clipped time series 220, combines adjacent data points with the data point to determine an average value, which are used to generate first filtered, clipped time series 228. Time-based filter(s) 208 may generate a second filtered, clipped time series 230 for a second window size (e.g., daily) based on a filtering function that, for each data point in clipped time series 220, combines adjacent points for a given data point of clipped time series 220 that are further in vicinity than the adjacent data points utilized to generate first filtered, clipped time series 228. Time-based filter(s) 208 may generate a third filtered, clipped time series 232 for a third window size (e.g., weekly) based on a filtering function that, for each data point in clipped time series 220, combines adjacent points for a given data point of clipped time series 220 that are further in vicinity than the adjacent data points utilized to generate second filtered, clipped time series 230. Time series 216, clipped time series 220, first filtered time series 222, second filtered time series 224, third filtered time series 226, first filtered, clipped time series 228, second filtered, clipped time series 230, and third filtered, clipped time series 232 may be provided to combiner 210

Combiner 210 may be configured to combine time series 216 with first filtered time series 222 to generate a first combined time series 234, combine time series 216 with second filtered time series 224 to generate a second combined time series 236, combine time series 216 with third filtered time series 226 to generate a third combined time series 238, combine clipped time series 220 with first filtered, clipped time series 228 to generate a fourth combined time series 240, combine clipped time series 220 with second filtered, clipped time series 230 to generate a fifth combined time series 242, and combine clipped time series 220 with third filtered, clipped time series 232 to generate a sixth combined time series 244. Combiner 210 may perform a Cartesian multiplication operation to perform the above-referenced combinations to generate first combined time series 234, second combined time series 236, third combined time series 238, fourth combined time series 240, fifth combined time series 242, and sixth combined time series 244.

Transformer 212 may be configured to perform an FFT on each of time series 216, clipped time series 220, first combined time series 234, second combined time series 236, third combined time series 238, fourth combined time series 240, fifth combined time series 242, and sixth combined time series 244 to detect seasonality for each time series 216, clipped time series 220, first combined time series 234, second combined time series 236, third combined time series 238, fourth combined time series 240, fifth combined time series 242, and sixth combined time series 244. The foregoing process considerably increases the probability of detecting the seasonality in at least one of the generated time series. It is noted that transformer 212 attempts to find seasonality in original time series (i.e., time series 216) to not hinder the seasonality detection in the event that clipped time series 220 no longer includes the seasonality to do the clipping operation performed by clipper 206. If a seasonal pattern is detected, transformer 212 outputs a detected seasonal pattern 246. In the event that more than one seasonal pattern is detected (e.g., a daily seasonality and a weekly seasonality), the longest seasonal pattern (e.g., the weekly seasonality) is used to model the data because they are multiples of each other. When modeling, for example, a weekly seasonal pattern also having a daily seasonality, the entire daily seasonality is contained within the weekly seasonal pattern.

It is noted that the window sizes utilized by time-based filter(s) 208 are purely exemplary and that any window size (e.g., monthly, yearly, etc.) may be utilized to determine seasonality for different time frames (e.g., monthly, seasonality, yearly seasonality, etc.).

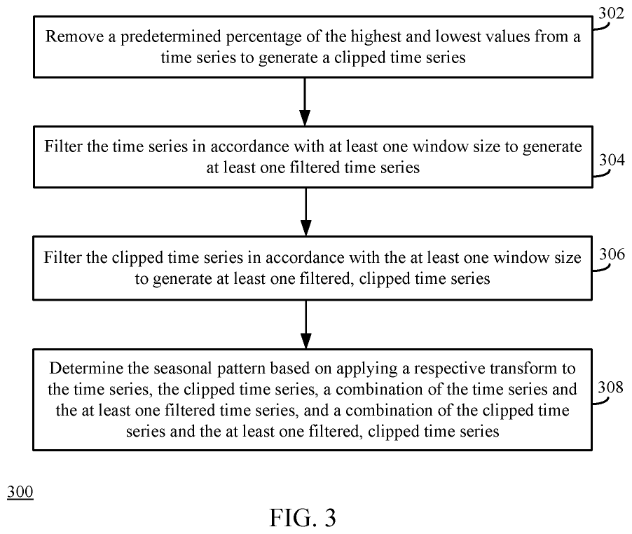

Accordingly, a seasonal pattern may be determined in a time series in many ways. For example, FIG. 3 shows a flowchart 300 of a method for determining a seasonal pattern in a time series in accordance with an example embodiment. In an embodiment, flowchart 300 may be implemented by system 200 shown in FIG. 2, although the method is not limited to that implementation. Accordingly, flowchart 300 will be described with continued reference to FIG. 2. Other structural and operational embodiments will be apparent to persons skilled in the relevant art(s) based on the discussion regarding flowchart 300 and system 200 of FIG. 2.

Flowchart 300 begins with step 302. In step 302, a predetermined percentage of the highest and lowest values from a time series is removed to generate a clipped time series. For example, with reference to FIG. 2, clipper 206 may remove a predetermined percentage of the highest and lowest values (e.g., 5% of the highest and lowest values) from time series 216 to generate clipped time series 220.

In step 304, the time series is filtered in accordance with at least one window size to generate at least one filtered time series. For example, with reference to FIG. 2, time-based filter(s) 208 may filter time series 216 in accordance with at least one window size to generate at least one filtered time series. For instance, time-based filter(s) 208 may filter time series 216 in accordance with a first window size (e.g., hourly) to generate a first filtered time series 222, filter time series 216 in accordance with a second window size (e.g., daily) to generate a second filtered time series 224, and so on and so forth.

In step 306, the clipped time series is filtered in accordance with the at least one window size to generate at least one filtered, clipped time series. For example, with reference to FIG. 2, time-based filter(s) 208 may filter clipped time series 220 in accordance with at least one window size to generate at least one filtered, clipped time series. For instance, time-based filter(s) 208 may filter clipped time series 220 in accordance with a first window size (e.g., hourly) to generate a first filtered, clipped time series 228, filter clipped time series 220 in accordance with a second window size (e.g., daily) to generate a second filtered, clipped time series 230, and so on and so forth.

In step 308, the seasonal pattern is determined based on applying a respective transform to the time series, the clipped time series, a combination of the time series and the at least one filtered time series, and a combination of the clipped time series and the at least one filtered, clipped time series. For example, with reference to FIG. 2, transformer 212 may apply a respective transform to time series 216, clipped time series 220, a first combination of time series 216 and filtered time series 222 (i.e., first combined time series 234), a second combination of time series 216 and filtered time series 224 (i.e., second combined time series 236), a third combination of time series 216 and filtered time series 226 (i.e., third combined time series 238), a fourth combination of clipped time series 220 and filtered, clipped time series 228 (i.e., fourth combined time series 240), a fifth combination of clipped time series 220 and filtered, clipped time series 230 (i.e., fifth combined time series 242), and/or a sixth combination of clipped time series 220 and filtered, clipped time series 236 (i.e., sixth combined time series 244). The transform applied to each of time series 216, clipped time series 220, first combined time series 234, second combined time series 236, third combined time series 238, fourth combined time series 240, fifth combined time series 242, and sixth combined time series 244 may be an FFT. In the event that more than one seasonal pattern is detected (e.g., a daily seasonality determined based on an FFT applied to second combined time series 236 or fifth combined time series 242 and a weekly seasonality determined based on an FFT applied to third combined time series 238 or sixth combined time series 244), the longest seasonal pattern (e.g., the weekly seasonality) is used to model the data because they are multiples of each other.

B. Model Selection for Generating Dynamic Thresholds

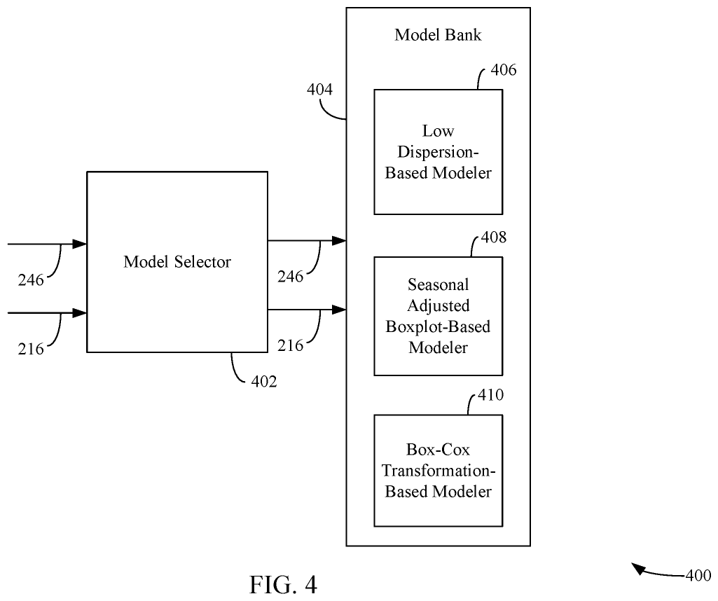

Once seasonal pattern 246 is detected from time series 216 using the techniques described above with reference to Subsection A, seasonal pattern 246 and time series 216 (e.g., the most recent data values collected for time series 216) may be provided to a model selector to determine the optimal model for generating dynamic thresholds for a particular metric. For example, FIG. 4 is a block diagram of a system 400 for determining an optimal model for generating dynamic thresholds for a particular metric in accordance with an embodiment. As shown in FIG. 4, system 400 includes a model selector 402 and a model bank 404. Model bank 404 may comprise a memory that stores a plurality of different statistical modelers that are utilized to determine dynamic thresholds based on time series 216 and seasonal pattern 246. For example, as shown in FIG. 4, model bank 404 includes a low dispersion-based modeler 406, a seasonal adjusted boxplot-based modeler 408, and a Box-Cox transformation-based modeler 410. Each of model selector 402 and model bank 404 may be included in dynamic threshold-based alert engine 118, as described above with reference to FIG. 1.

Model selector 402 may be configured to perform a statistical analysis based on time series 216 and/or seasonal pattern 246 to automatically determine which modeler should be utilized to determine the automatic thresholds. For instance, model selector 402 may analyze the range, mean, variance, standard deviation, spread, etc., of time series 216 and/or seasonal pattern 246. Low dispersion modeler 406 may be selected if the analysis indicates that time series 216 and/or seasonal pattern 246 is relatively constant and/or rarely changes). If time series 216 and/or seasonal pattern 246 is relatively variable (e.g., has a sinusoidal pattern, high variance, etc.), model selector 402 may select one of a seasonal adjusted boxplot-based modeler 408 or Box-Cox transformation-based modeler 410. Model selector 402 may select Box-Cox transformation-based modeler 410 if time series 216 and/or seasonal pattern 246 has a majority of positive values (e.g., does not include values that are less than or equal to 0) and may select seasonal adjusted boxplot-based modeler 408 if time series 216 and/or seasonal pattern 246 includes values that are less than or equal to 0.

Box-Cox transformation-based modeler 410 has an inherent limitation dealing with non-positive values. Thus, non-positive values may be removed from time series 216 before applying Box-Cox transformation-based modeler 410. In some metrics, a substantial part of the data (more than 80%) is zeros. A common example for such metrics is a request count or network traffic for processes which are active only on a part of the day. In such situations, Box-Cox transformation-based modeler 410 performs poorly because too little values remain after removal of zeros. Accordingly, seasonal adjusted boxplot-based modeler 408 may be utilized in certain scenarios.

Generally, Box-Cox transformation-based modeler 410 generates more accurate thresholds than compared to seasonal adjusted boxplot-based modeler 408, as more data points are analyzed (as will be described below with reference to Subsection B.2). Seasonal adjusted boxplot-based modeler 408 may be utilized as a fallback modeler in the event that time series 216 and/or seasonal pattern 246 includes values that are less than or equal to 0.

Additional details regarding seasonal adjusted boxplot-based modeler 408 and Box-Cox transformation-based modeler 410 are described below with reference to Subsections B.1 and B.2, respectively.

After determining which modeler to utilize, the selected modeler automatically generates the dynamic thresholds. In the event that the analysis determines that none of the modelers are applicable, then no dynamic thresholds are automatically generated. It is noted that model bank 404 may store any number of modelers and that low dispersion-based modeler 406, seasonal adjusted boxplot-based modeler 408 and Box-Cox transformation-based modeler 410 are some examples of the modelers that may be utilized to generate thresholds.

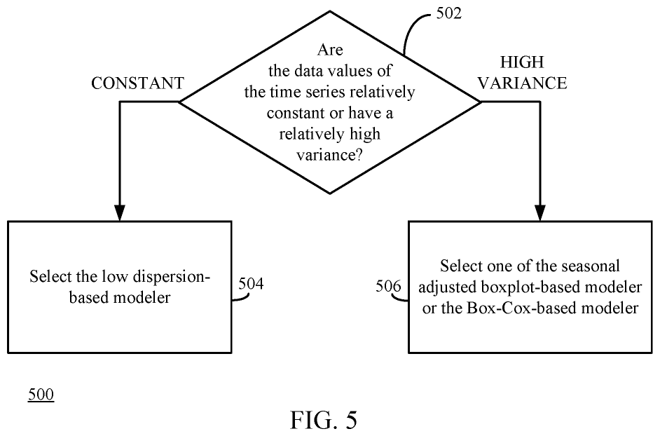

Accordingly, a modeler for generating dynamic thresholds may be selected in many ways. For example, FIG. 5 shows a flowchart 500 of a method for selecting a modeler for generating dynamic thresholds in accordance with an example embodiment. In an embodiment, flowchart 500 may be implemented by system 400 shown in FIG. 4, although the method is not limited to that implementation. Accordingly, flowchart 500 will be described with continued reference to FIG. 4. Other structural and operational embodiments will be apparent to persons skilled in the relevant art(s) based on the discussion regarding flowchart 500 and system 400 of FIG. 4.

Flowchart 500 begins with step 502. In step 502, a determination is made as to whether the data values of the time series are relatively constant or have a relatively high variance. For example, with reference to FIG. 4, model selector 402 may determine whether the data values of time series 216 are relatively constant or have a relatively high variance. If a determination is made that the data values of the time series are relatively constant, flow continues to step 504. Otherwise, flow continues to step 506.

In step 504, the low dispersion-based modeler is selected. For example, with reference to FIG. 4, model selector 402 selects low dispersion-based modeler 406.

In step 506, one of the seasonal adjusted boxplot-based modeler or the Box-Cox transformation-based modeler is selected. For example, with reference to FIG. 4, model selector 402 selects one of seasonal adjusted boxplot-based modeler 408 or Box-Cox transformation-based modeler 410.

In accordance with one or more embodiments, selecting one of the seasonal adjusted boxplot-based modeler or the Box-Cox transformation-based modeler comprises determining whether the data values of the time series comprise non-positive values. Based at least on determining that the data values of the time series comprise non-positive values, the seasonal adjusted boxplot-based modeler is selected. Based at least on determining that the data values of the time series do not comprise non-positive values, the Box-Cox transformation-based modeler is selected. For example, with reference to FIG. 4, model selector 402 may select seasonal adjusted boxplot-based modeler 408 based at least on determining that the data values of the time series comprise non-positive values and may select Box-Cox transformation-based modeler 410 based at least on determining that the data values of the time series do not comprise non-positive values.

1. Seasonal Adjusted Boxplot Modeler

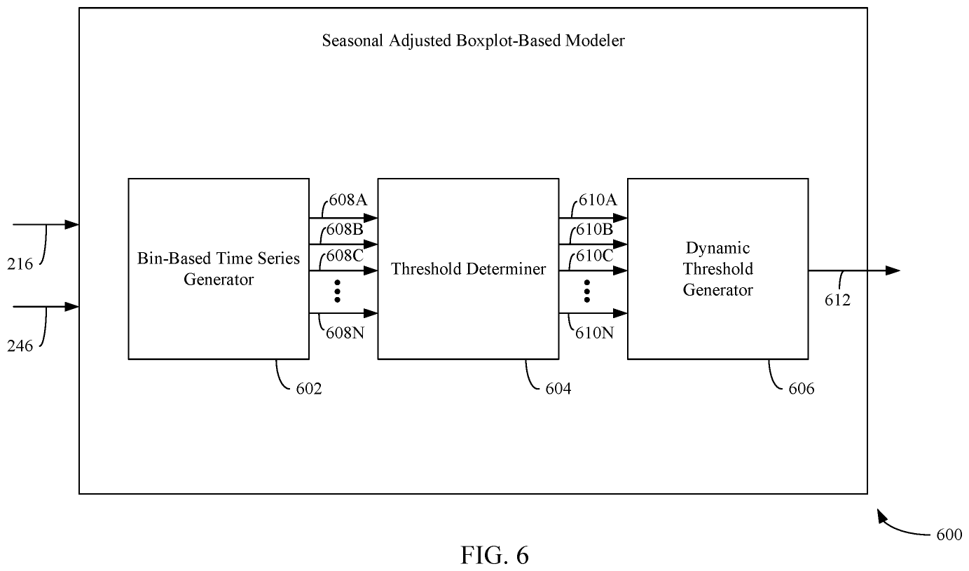

FIG. 6 is a block diagram of a seasonal adjusted boxplot-based modeler 600 in accordance with an example embodiment. Seasonal adjusted boxplot-based modeler 600 is an example of seasonal adjusted boxplot-based modeler 408, as shown in FIG. 4. As shown in FIG. 6, seasonal adjusted boxplot-based modeler 408 may include a bin-based time series generator 602, a threshold determiner 604, and a dynamic threshold generator 606.

Bin-based time series generator 602 may be configured to de-seasonalize seasonal pattern 246 to generate a plurality of different time series based on seasonal pattern 246. Each generated time series may be based on a particular bin (or bucket) associated with seasonal pattern 246. A bin may represent a particular time interval. For example, each bin may represent a particular hour of a given day. In this case, the number of bins would be 24 (1 bin for each hour of the day), and therefore, the number of time series generated would also be 24. In another example, each bin may represent a ten-minute interval. In a scenario in which seasonal pattern 246 comprises 7 days of data (or 10,008 minutes' worth of data), the number of bins would be 1,008, and therefore, the number of time series generated would also be 1,008. It is noted that any time interval may be utilized.

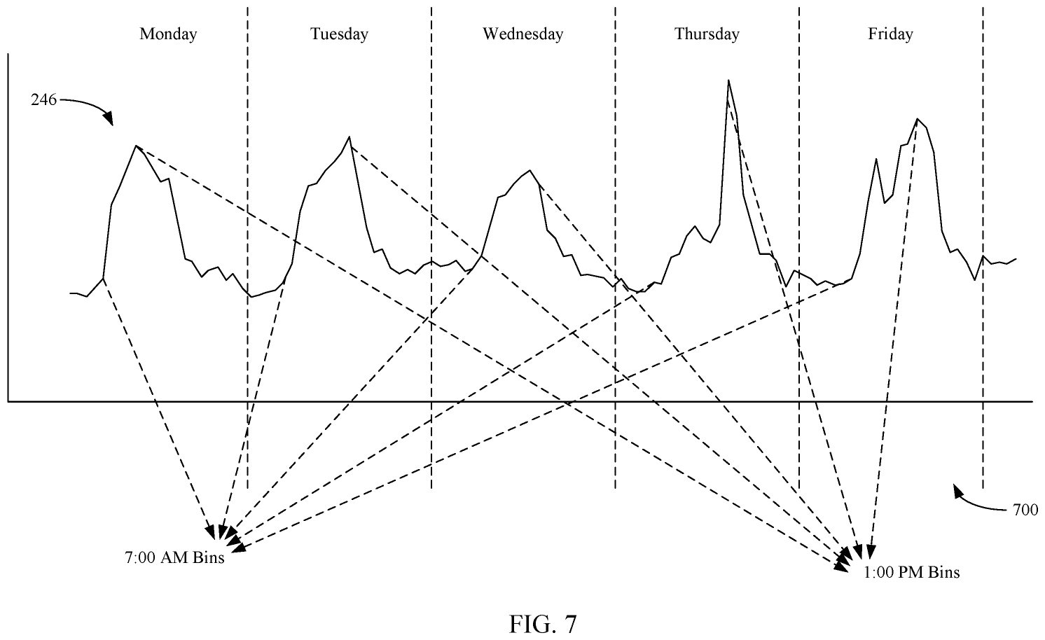

For a particular bin, bin-based time series generator 602 may determine each of value of the metric for that bin in seasonal pattern 246. For example, FIG. 7 shows a graph 700 depicting seasonal pattern 246 in accordance with an example embodiment. In the example shown in FIG. 7, seasonal pattern 246 includes 5 days' worth of data. For a first bin, bin-based time series generator 602 determines the values of seasonal pattern 246 located at the first bin. For a second bin, bin-based time series generator 602 determines the values of seasonal pattern 246 located at the second bin, and so on and so forth. In the example shown in FIG. 7, each bin represents a particular of the day. Because there are 5 days' worth of data, the number of data points collected for a particular bin is 5. For instance, with further reference to FIG. 7, suppose a first bin corresponds to 7:00 AM and a second bin corresponds to 1:00 PM. For the 7:00 AM bin, bin-based time series generator 602 determines the value of the metric at each 7:00 AM bin and generates a first time series based on the 5 values collected for the 7:00 AM bin. Similarly, for the 1:00 PM bin, bin-based time series generator 602 determines the value of the metric at each 1:00 PM bin and generates a second time series based on the 5 values collected for the 1:00 PM bin.

Referring again to FIG. 6, bin-based time series generator 602 provides the generated bin-based time series (shown as bin-based time series 608A-608N) to threshold determiner 604. Threshold determiner 604 may be configured to generate a minimum and/or maximum threshold for each of bin-based time series 608A-608N. For instance, for each of bin-based time series 608A-608N, threshold determiner 604 may determine its minimum value and generate a minimum threshold based thereon. Similarly, threshold determiner 604 may determine its maximum value and generate a maximum threshold based thereon. Threshold determiner 604 may utilize an adjusted boxplot algorithm to determine the minimum and/or maximum values and/or thresholds.

The most straightforward and popular method for generating thresholds is the “3-sigma” rule, according to which one estimates the sample mean and standard deviation and sets the boundaries at 3 standard deviations from the mean. However, it is well known that the sample mean and standard deviation are non-robust statistics, prone to significant errors in the presence of outliers.

To deal with this caveat, several methods based on robust statistics have been proposed. In accordance with an embodiment, threshold determiner 604 utilizes a modified version of Tukey's method (a.k.a. boxplot) to estimate the boundaries of the normal behavior of the data.

Given that P₂₅ and P₇₅ are the 25^{th} and 75^{th} percentiles of the data, the classic Tukey's test sets the higher and lower boundaries at P₇₅+K·(P₇₅−P₂₅) and P₂₅−K·(P₇₅−P₂₅), respectively. K in this equation is a predetermined factor, and usually K=1.5 defines boundaries for “mild outliers” and K=3 defines boundaries for “extreme outliers”.

In the modified version, since it is not very rare that the interquartile range (P₇₅−P₂₅) in telemetry data is 0, the inter-percentile range between the 90^{th} and 10^{th} percentiles (P₉₀−P₁₀) is used instead. Thus, the minimum and/or maximum thresholds may be set at P₉₀+\tilde{K}·(P₉₀−P₁₀) and P₁₀−\tilde{K}·(P₉₀−P₁₀), respectively.

The \tilde{K}(≈0.55) factor applied may be determined so that if the data were normally distributed, the minimum and/or maximum thresholds will be the same as those set by the classic Tukey's method with K=1.5. In addition, minimum and/or maximum thresholds for different detection sensitivity levels can be set by using a factor larger than \tilde{K}. In accordance with an embodiment, 1.5×\tilde{K} and 2×\tilde{K} for used for medium and extreme outliers, respectively. Furthermore, to account for possible skewness of the data, an adjusted boxplot may be used that adds a compensating factor that is a function of the medcouple.

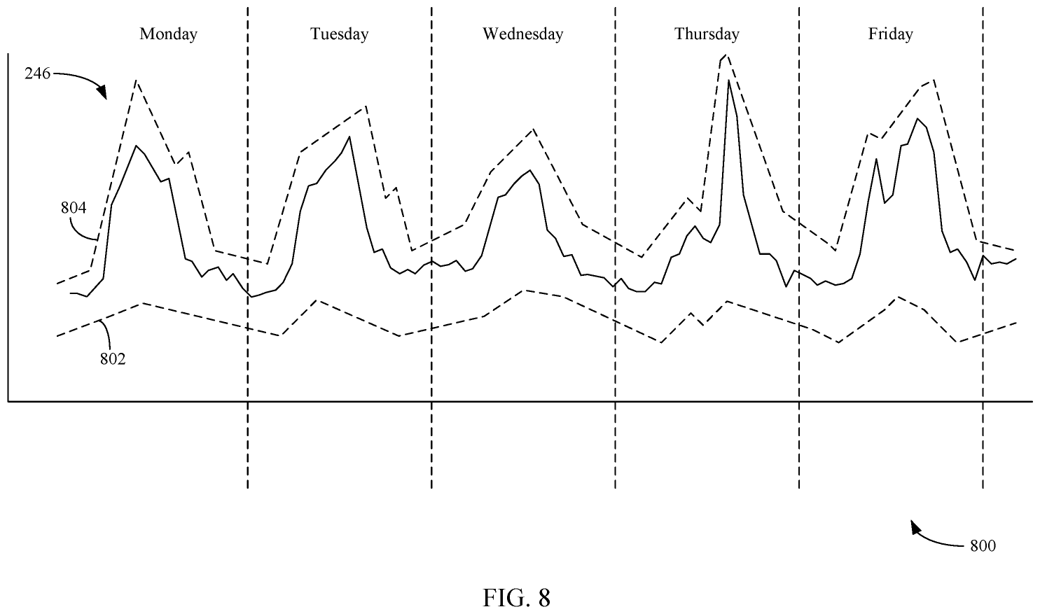

Threshold determiner 604 provides the determined thresholds (shown as thresholds (thresholds 610A-610N) to dynamic threshold generator 606. Dynamic threshold generator 606 may be configured to compose (or combine) each of thresholds 610A-610N to generate a continuous, dynamic threshold 612, which tracks the seasonality of seasonal pattern 246. For instance, with reference to FIG. 8, FIG. 8 depicts a graph showing a minimum threshold 802 and a maximum threshold 804 generated based on seasonal pattern 246 in accordance with an example embodiment. As shown in FIG. 8, minimum threshold 802 and a maximum threshold 804 dynamically track the seasonality of seasonal pattern 246 (as opposed to static, straight-line thresholds).

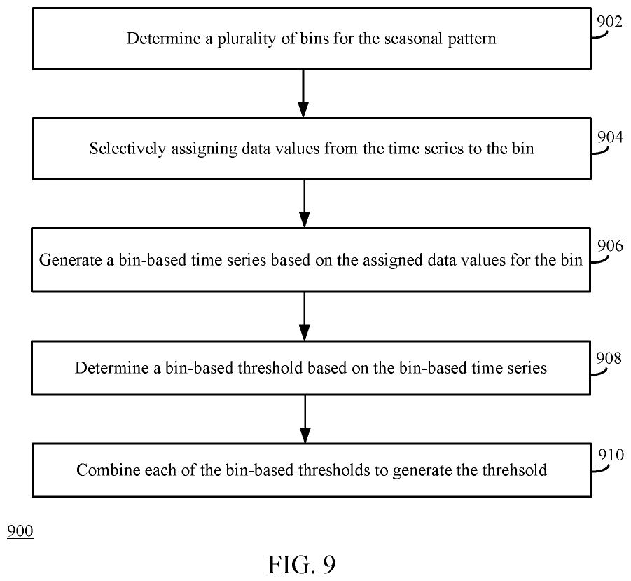

Accordingly, a seasonal adjusted boxplot-based modeler may be utilized to generate dynamic thresholds in many ways. For example, FIG. 9 shows a flowchart 900 of a method for generating dynamic thresholds using a seasonal adjusted boxplot-based modeler in accordance with an example embodiment. In an embodiment, flowchart 900 may be implemented by system 600 shown in FIG. 6, although the method is not limited to that implementation. Accordingly, flowchart 900 will be described with continued reference to FIG. 6. Other structural and operational embodiments will be apparent to persons skilled in the relevant art(s) based on the discussion regarding flowchart 900 and system 600 of FIG. 6.

Flowchart 900 begins with step 902. In step 902, a plurality of bins for the seasonal pattern is determined. For example, with reference to FIG. 6, bin-based time series generator 602 may determine a plurality of bins for seasonal pattern 246.

In step 904, for each bin of the plurality of bins, data values from the time series are selectively assigned to the bin. For example, with reference to FIG. 6, bin-based time series generator 602 selectively assigns data values from time series 216 to the bin.

In step 906, for each bin of the plurality of bins, a bin-based time series is generated based on the assigned data values for the bin. For example, with reference to FIG. 6, for each bin of the plurality of bins, bin-based time series generator 602 generates a bin-based time series (shown as bin-based time series 608A-608N) based on the assigned data values for the bin.

In step 908, for each bin of the plurality of bins, a bin-based threshold is determined based on the bin-based time series. For example, with reference to FIG. 6, threshold determiner 604 determines bin-based thresholds 610A-610N based on bin-based time series 608A-608N.

In step 910, each of the bin-based thresholds are combined to generate the threshold. For example, with reference to FIG. 6, dynamic threshold generator 606 combines bin-based thresholds 610A-610N to generate dynamic threshold 612.

2. Box-Cox Transformation-based Modeler

When forecasting a seasonal metric, several values of the same seasonal phase are usually required to establish a forecasting threshold; since forecasting metrics based on past behavior requires estimating the variation of metric values. Variation cannot be computed on a single value or be reliable on very few measurements. In some seasonality spans, such as weekly patterns, taking few weeks back to build a forecasting model might be wrong in terms of adapting to changes in models. So, in such cases, the use of several seasons is simply misleading. There is a need to reduce the time span used in building the forecast model.

A different approach is to use the entire data to predict the variation and make it a constant variation in all the seasonal phases. This approach is also problematic since in many cases, the variation of service metrics is somewhat correlative to the signal values. For example, the variation of traffic data is higher during business hours than during the night or weekends. As a result, after decomposing the seasonal behavior of the data, the random (or noisy) components remain. Such components might have constant variance or variance that changes over time.

By applying Box-Cox transformation-based modeler 410 to the seasonal decomposed variants of the data, all the residuals are changed to a common space on which bandwidth of the forecast belt can be estimated. At that point, an adjusted boxplot can be applied to the residuals. Therefore, a backward (or inverse) transform is applied to go back to the original metric values to have a ready model with seasonally-adjusted boxplot thresholds. The foregoing advantageously enables the creation of a forecasting seasonal model by using a very few numbers of seasons.

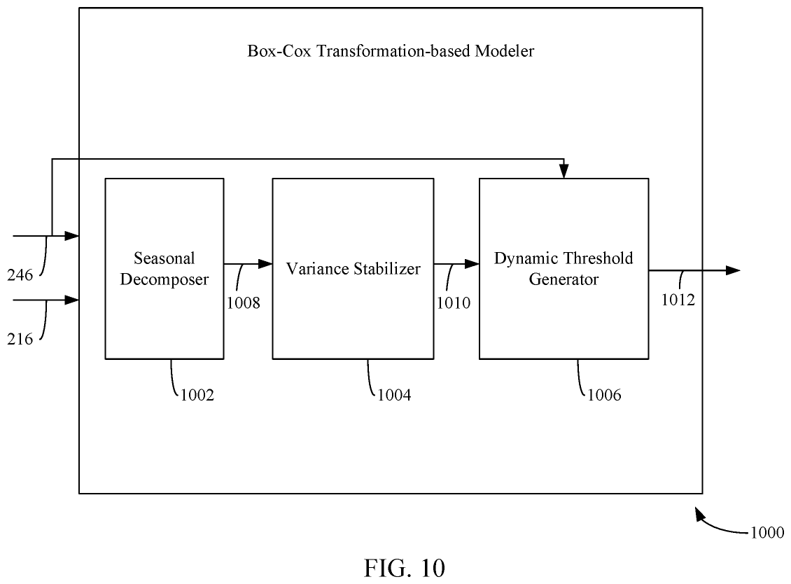

FIG. 10 is a block diagram of a Box-Cox transformation-based modeler 1000 in accordance with an example embodiment. Box-Cox transformation-based modeler 1000 is an example of Box-Cox transformation-based modeler 410, as shown in FIG. 4. As shown in FIG. 10, Box-Cox transformation-based modeler 1000 may include a seasonal decomposer 1002, a variance stabilizer 1004, and a dynamic threshold generator 1006.

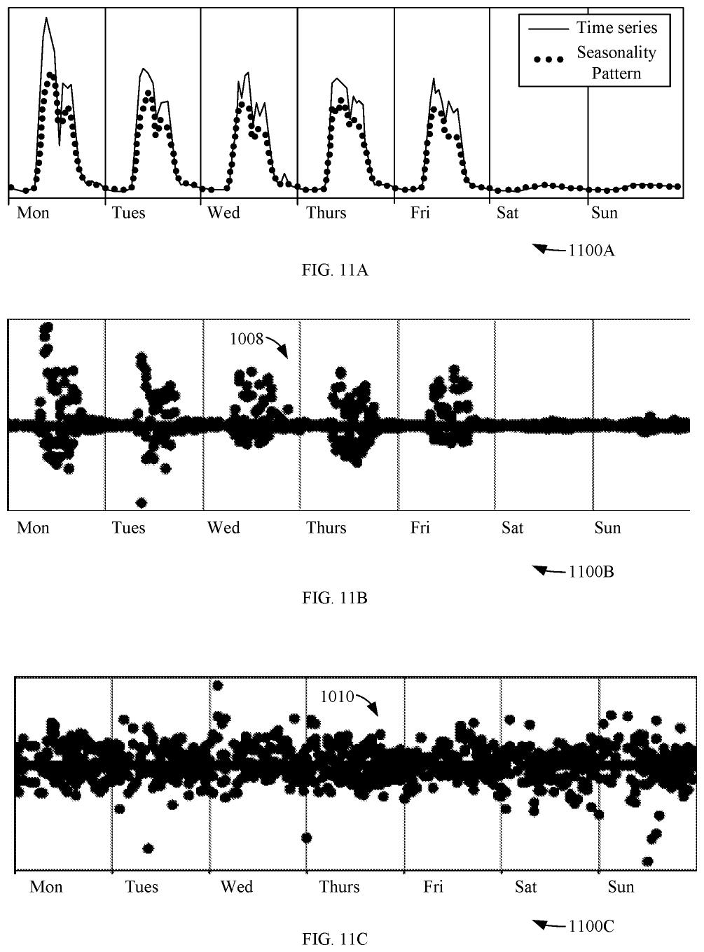

Seasonal decomposer 1002 may be configured to decompose the seasonal behavior of time series 216. For instance, seasonal decomposer 1002 may remove seasonal pattern 246 from time series 216. This may be performed by subtracting seasonal pattern 246 from time series 216. The remaining portion of time series 216 represents a natural random variation (or residual data) of time series 216. For instance, FIGS. 11A-11B depict graphs 1100A-1100B that show time series 216 and seasonal pattern 246. Graph 1100A shows time series 216 and seasonal pattern 246 superimposed thereon, before seasonal pattern 246 is removed. Graph 1100B shows residual data, which is the result of seasonal pattern decomposer 1002 removing seasonal pattern 246 from time series 216.

The issue is the residual data is that there is a varying degree of noise. When performing statistical analysis, it is desired to have the same level of noise all the time. Accordingly, a power transformation is performed to stabilize the noise in the residual data. For example, with reference to FIG. 10, seasonal decomposer 1002 provides residual data 1008 (which is represented in graph 1100B) to variance stabilizer 1004. Variance stabilizer 1004 performs a transform to stabilize the variance in noise in residual data 1008 to generate transformed residual data 1010. For instance, variance stabilizer 1004 may apply a non-linear, monotone transformation of residual data 1008. The transformation may be a Box-Cox transformation-based transformation. The transformation may include both a logarithmic and power transformation in accordance with Equation 1, which is shown below:

$${y}_{i}^{( λ ) } \text{:=} \{ \begin{matrix}\frac{{y}_{i}^{λ} - 1}{λ} , & λ \neq 0 \\ ln ( {y}_{i} ) , & λ = 0\end{matrix} \qquad ( Equation 1 )$$

where yᵢ and yᵢ^{(λ)} are the ith data point in the original and transformed scale, respectively. This transformation formula is defined as such so the transformation is continuous in λ as it approaches 0. The adequate λ for a given time series is estimated by maximizing the log likelihood function of the residuals given they are normally distributed. FIG. 11C depicts a graph 1100C showing transformed residual data 1010 (i.e., after seasonal pattern 246 is subtracted from time series 216 and after applying the Box-Cox-based transformation on residual data 1008). As shown in graph 1100C, there is no apparent change in the variation during the week (i.e., transformed residual data 1010 is more evenly distributed throughout the week than compared to residual data 1008).

Dynamic threshold generator 1006 may be configured generate a continuous, dynamic threshold 1012, which tracks the seasonality of seasonal pattern 246. For example, dynamic threshold generator 1006 may be configured to generate at least one of a minimum threshold and a maximum threshold for transformed residual data 1010. Because transformed residual data 1010 is relatively constant, the minimum and/or maximum thresholds may be relatively constant threshold(s). After determining the minimum and/or maximum thresholds, dynamic threshold generator 1006 may perform an inverse transformation on the minimum and maximum thresholds to reintroduce the variance (i.e., the transform performed by variance stabilizer 1004 is reversed). Thereafter, the transformed minimum and/or maximum thresholds are combined with seasonal pattern 246, thereby resulting in minimum and/or maximum thresholds (i.e., dynamic thresholds 1012) that tracks seasonal pattern 246.

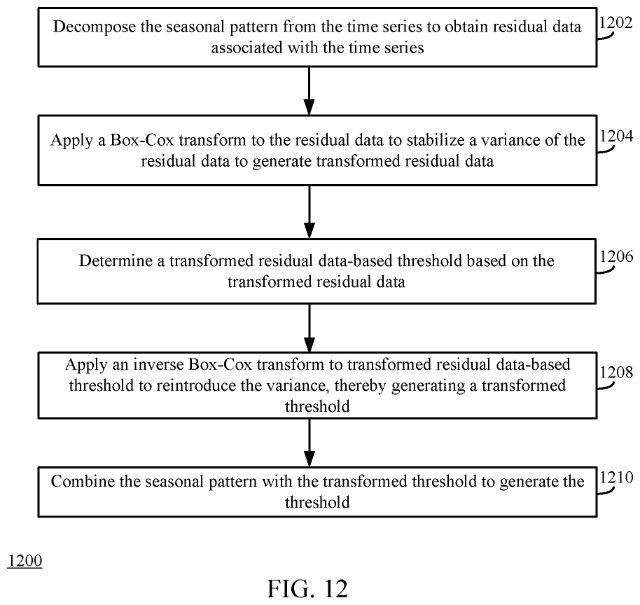

Accordingly, a Box-Cox transformation-based modeler may be utilized to generate dynamic thresholds in many ways. For example, FIG. 12 shows a flowchart 1200 of a method for generating dynamic thresholds using a Box-Cox transformation-based modeler in accordance with an example embodiment. In an embodiment, flowchart 1200 may be implemented by system 1000 shown in FIG. 10, although the method is not limited to that implementation. Accordingly, flowchart 1200 will be described with continued reference to FIG. 10. Other structural and operational embodiments will be apparent to persons skilled in the relevant art(s) based on the discussion regarding flowchart 1200 and system 1000 of FIG. 10.

Flowchart 1200 begins with step 1202. In step 1202, the seasonal pattern is decomposed from the time series to obtain residual data associated with the time series. For example, with reference to FIG. 10, seasonal decomposer 1002 decomposes (e.g., removes) seasonal pattern 246 from time series 216 to obtain residual data 1008 associated with time series 216. For instance, FIG. 11B shows an example of residual data 1008 that is obtained from removing seasonal pattern 246 from time series 216.

In step 1204, a Box-Cox transform is applied to the residual data to stabilize a variance of the residual data to generate transformed residual data. For example, with reference with FIG. 10, variance stabilizer 1004 applies a Box-Cox transform to residual data 1008 to stabilize the variance of residual data 1008 to generate transformed residual data 1010. For instance, FIG. 11C shows an example of transformed residual data 1010.

In step 1206, a transformed residual data-based threshold is determined based on the transformed residual data. For example, with reference to FIG. 10, dynamic threshold generator 1006 may generate at least one transformed residual data-based threshold (e.g., a minimum and/or a maximum threshold) based on transformed residual data 1010.

In step 1208, an inverse Box-Cox transform is applied to the transformed residual data-based threshold to reintroduce the variance, thereby generating a transformed threshold. For example, with reference to FIG. 10, dynamic threshold generator 1006 may apply an inverse Box-Cox transform to the transformed residual data-based threshold to reintroduce the variance, thereby generating a transformed threshold.

In step 1210, the seasonal pattern is combined with the transformed threshold to generate the threshold. For example, with reference to FIG. 10, dynamic threshold generator 1006 may combine seasonal pattern 246 with the transformed threshold to generate at least one dynamic threshold 1012.

C. Method for Issuing Alerts Indicative of Anomalous Resource Usage based on Dynamic Thresholds

Once the dynamic thresholds are determined for a particular metric, the determined dynamic thresholds may be utilized to determine whether the metric exhibits anomalous behavior (e.g., an excessive amount or abnormally low number of requests, an excessive usage of CPU cycles, memory and/or storage, etc.) as the corresponding computing resource(s) continue to operate. If the determined thresholds are exceeded, an alert indicating anomalous resource usage with respect to the computing resource(s) may be provided to a user.

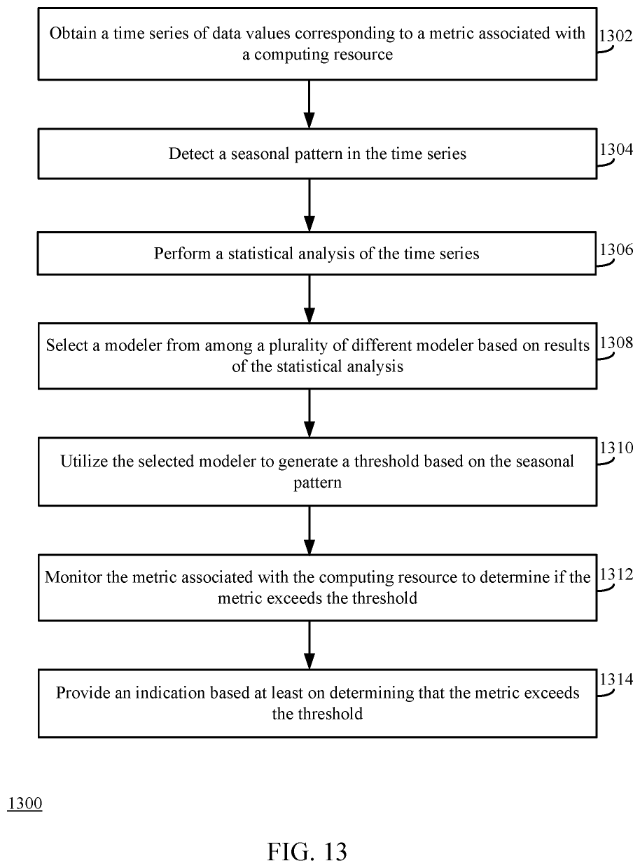

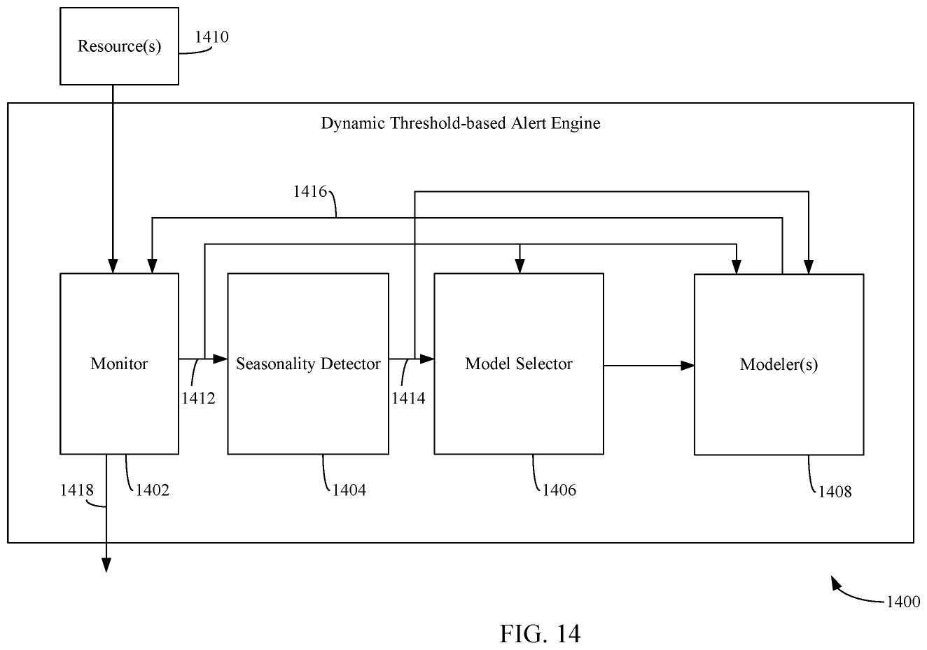

For example, FIG. 13 shows a flowchart 1300 of a method for issuing alerts indicative of anomalous resource usage based on dynamic thresholds in accordance with an example embodiment. In an embodiment, flowchart 1300 may be implemented by dynamic threshold-based alert engine 1400 of FIG. 14, although the method is not limited to those implementations. Accordingly, flowchart 1300 will be described with reference to FIG. 14. FIG. 14 is a block diagram of dynamic threshold-based alert engine 1400 in accordance with an embodiment. As shown in FIG. 14, dynamic threshold-based alert engine 1400 comprises a monitor 1402, a seasonality detector 1404, a model selector 1406, and one or more modeler(s) 1408. Dynamic threshold-based alert engine 1400 is an example of dynamic threshold-based alert engine 118, as described above with reference to FIG. 1. Monitor 1402 and seasonality detector 1404 are examples of monitor 202 and seasonality detector 204, as described above with reference to FIG. 2. Model selector 1406 is an example of model selector 402, as described above with reference to FIG. 4. Modeler(s) 1408 are examples of low-dispersion-based modeler 406, seasonal adjusted boxplot-based modeler 408, and Box-Cox transformation-based modeler 410, as described above with reference to FIG. 4. Other structural and operational embodiments will be apparent to persons skilled in the relevant art(s) based on the discussion regarding flowchart 1400 and dynamic threshold-based alert engine 1400.

Flowchart 1300 begins with step 1302. In step 1302, a time series of data values corresponding to a metric associated with a computing resource is obtained. For example, with reference to FIG. 14, monitor 1402 obtains a time series 1412 of data values corresponding to a metric associated with one or more resources 1410. Resource(s) 1410 are examples of resources 218, as described above with reference to FIG. 2. Time series 1412 is an example of time series 216, as described above with reference to FIG. 2.

In step 1304, a seasonal pattern in the time series is detected. For example, with reference to FIG. 14, seasonality determiner 1404 may detect a seasonal pattern 1414 in time series 1412. Seasonal pattern 1414 is an example of seasonal pattern 246, as described above with reference to FIG. 2.

In accordance with one or more embodiments, the seasonal pattern may be determined in accordance with system 200 of FIG. 2 and flowchart 300 of FIG. 3.

In step 1306, a statistical analysis of the time series is performed. For example, with reference to FIG. 14, model selector 1406 may perform a statistical analysis of time series 1412.

In step 1308, a modeler is selected from among a plurality of different modelers based on results of the statistical analysis. For example, with reference to FIG. 14, model selector 1406 may select a modeler from modeler(s) 1408 based on results of the statistical analysis.

In accordance with one or more embodiments, the plurality of different modelers comprises at least one of a low dispersion-based modeler, a seasonal adjusted boxplot-based modeler, or a Box-Cox transformation-based modeler. For example, with reference to FIG. 4, the plurality of different modelers comprises at least one of low dispersion-based modeler 406, seasonal adjusted boxplot-based modeler 408, or Box-Cox transformation-based modeler 410.

In accordance with one or more embodiments, the modeler may be selected in accordance with system 400 of FIG. 4 and flowchart 500 of FIG. 5

In step 1310, the selected modeler is utilized to generate a threshold based on the seasonal pattern. For example, with reference to FIG. 14, the selected modeler of modeler(s) 1408 is utilized to generate a dynamic threshold 1416. With reference to FIG. 6, in an embodiment in which the selected modeler is seasonal adjusted boxplot-based modeler 600, seasonal adjusted boxplot-based modeler 600 generates dynamic threshold 612 based on seasonal pattern 246. Dynamic threshold 612 may be generated in accordance with flowchart 900 of FIG. 9. With reference to FIG. 10, in an embodiment in which the selected modeler is Box-Cox transformation-based modeler 1000, Box-Cox transformation-based modeler 1000 generates dynamic threshold 1012 based on seasonal pattern 246. Dynamic threshold 1012 may be generated in accordance with flowchart 1200 of FIG. 12.

In step 1312, the metric associated with the computing resource is monitored to determine whether the metric exceeds the threshold. For example, with reference to FIG. 14, monitor 1402 may monitor the metric associated with resource(s) 1410 to determine whether the metric exceeds dynamic threshold 1416. For instance, monitor 1402 may monitor one or more data points indicative of the metric and compare the data points to dynamic threshold 1416 to determine whether such data point(s) exceed dynamic threshold 1416.

In step 1314, an indication is provided based at least on determining that the metric exceeds the threshold. For example, with reference to FIG. 14, monitor 1402 may provide an indication 1418 based at least on determining that the metric exceeds dynamic threshold 1416. For instance, with reference to FIG. 8, if the metric exceeds minimum threshold 802 or maximum threshold 804, monitor 1404 may provide indication 1418.

In accordance with one or more embodiments, providing the indication includes issuing an alert. The alert (e.g., indication 1418) may be issued to computing device 104, as shown in FIG. 1. Examples of indication 1418 include, but are not limited to an e-mail message, a phone call, a text message, a short messaging service (SMS) message, and/or the like. Monitor 1402 may further provide an indication that indicate which of the data point(s) are anomalous (i.e., exceeded dynamic threshold 1416).

In accordance with one or more embodiments, indication 1418 may trigger one or more actions to be performed with respect to resources 1410. For instance, additional resources of resources 1410 may be automatically allocated to handle an excessive amount of network requests, CPU usage, memory usage, etc. to compensate for the anomalous behavior.

### III. Example Computer System Implementation

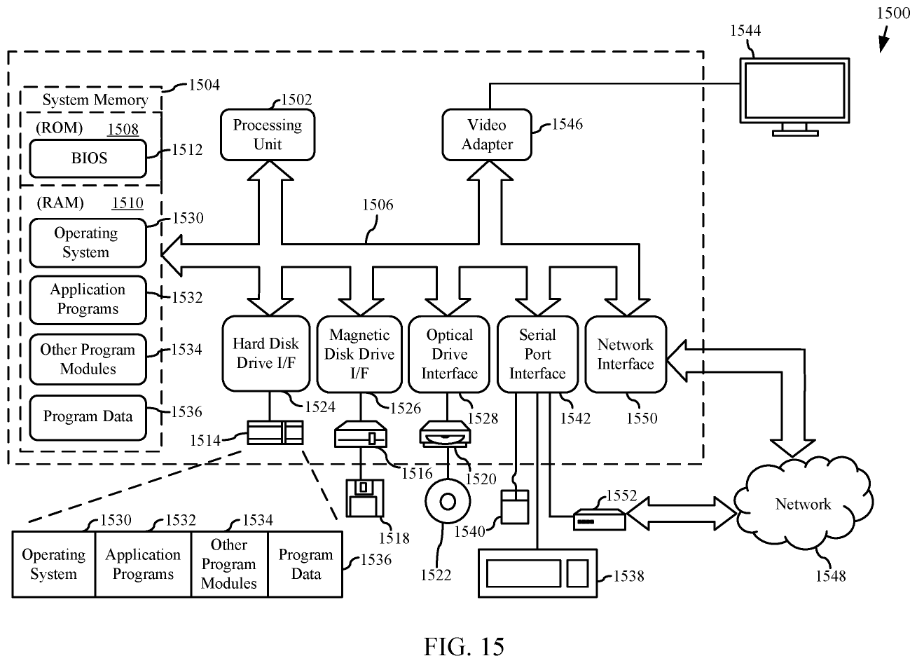

FIG. 15 depicts an example processor-based computer system 1500 that may be used to implement various embodiments described herein. For example, system 1500 may be used to implement any of nodes 108A-108B, 112A-112N, and/or 114A-114N, storage node(s) 110, computing device 104, and dynamic threshold-based alert engine 118 of FIG. 1, monitor 202, storage 214, seasonality determiner 204, clipper 206, time-based filter(s) 208, combiner 210, and transformer 212 of FIG. 2, model selector 402, model bank 404, low dispersion-based modeler 406, seasonal adjusted boxplot-based modeler 408, and Box-Cox transformation-based modeler 410 of FIG. 4, seasonal adjusted boxplot-based modeler 600, bin-based time series generator 602, threshold determiner 604, dynamic threshold generator 606 of FIG. 6, Box-Cox-based modeler 1000, seasonal decomposer 1002, variance stabilizer 1004, and dynamic threshold generator 1006 of FIG. 10, and dynamic threshold-based alert engine 1400, monitor 1402, seasonality detector 1404, model selector 1406, and modeler(s) 1408 of FIG. 14, and/or any of the components respectively described therein. System 1400 may also be used to implement any of the steps of any of the flowcharts of FIGS. 3, 5, 9, 10, 12, and 13, as described above. The description of system 1500 provided herein is provided for purposes of illustration, and is not intended to be limiting. Embodiments may be implemented in further types of computer systems, as would be known to persons skilled in the relevant art(s).

As shown in FIG. 15, system 1500 includes a processing unit 1502, a system memory 1504, and a bus 1506 that couples various system components including system memory 1504 to processing unit 1502. Processing unit 1502 may comprise one or more circuits, microprocessors or microprocessor cores. Bus 1506 represents one or more of any of several types of bus structures, including a memory bus or memory controller, a peripheral bus, an accelerated graphics port, and a processor or local bus using any of a variety of bus architectures. System memory 1504 includes read only memory (ROM) 1508 and random access memory (RAM) 1510. A basic input/output system 1512 (BIOS) is stored in ROM 1508.

System 1500 also has one or more of the following drives: a hard disk drive 1514 for reading from and writing to a hard disk, a magnetic disk drive 1516 for reading from or writing to a removable magnetic disk 1518, and an optical disk drive 1520 for reading from or writing to a removable optical disk 1522 such as a CD ROM, DVD ROM, BLU-RAY™ disk or other optical media. Hard disk drive 1514, magnetic disk drive 1516, and optical disk drive 1520 are connected to bus 1506 by a hard disk drive interface 1524, a magnetic disk drive interface 1526, and an optical drive interface 1528, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 1530, one or more application programs 1532, other program modules 1534, and program data 1536. In accordance with various embodiments, the program modules may include computer program logic that is executable by processing unit 1502 to perform any or all of the functions and features of nodes 108A-108B, 112A-112N, and/or 114A-114N, storage node(s) 110, computing device 104, and dynamic threshold-based alert engine 118 of FIG. 1, monitor 202, storage 214, seasonality determiner 204, clipper 206, time-based filter(s) 208, combiner 210, and transformer 212 of FIG. 2, model selector 402, model bank 404, low dispersion-based modeler 406, seasonal adjusted boxplot-based modeler 408, and Box-Cox transformation-based modeler 410 of FIG. 4, seasonal adjusted boxplot-based modeler 600, bin-based time series generator 602, threshold determiner 604, dynamic threshold generator 606 of FIG. 6, Box-Cox-based modeler 1000, seasonal decomposer 1002, variance stabilizer 1004, and dynamic threshold generator 1006 of FIG. 10, and dynamic threshold-based alert engine 1400, monitor 1402, seasonality detector 1404, model selector 1406, and modeler(s) 1408 of FIG. 14, and/or any of the components respectively described therein, and/or any of the steps of any of the flowcharts of FIGS. 3, 5, 9, 10, 12, and 13, as described above. The program modules may also include computer program logic that, when executed by processing unit 1502, causes processing unit 1502 to perform any of the steps of any of the flowcharts of FIGS. 3, 5, 9, 10, 12, and 13, as described above.

A user may enter commands and information into system 1500 through input devices such as a keyboard 1538 and a pointing device 1540 (e.g., a mouse). Other input devices (not shown) may include a microphone, joystick, game controller, scanner, or the like. In one embodiment, a touch screen is provided in conjunction with a display 1544 to allow a user to provide user input via the application of a touch (as by a finger or stylus for example) to one or more points on the touch screen. These and other input devices are often connected to processing unit 1502 through a serial port interface 1542 that is coupled to bus 1506, but may be connected by other interfaces, such as a parallel port, game port, or a universal serial bus (USB). Such interfaces may be wired or wireless interfaces.

Display 1544 is connected to bus 1506 via an interface, such as a video adapter 1546. In addition to display 1544, system 1500 may include other peripheral output devices (not shown) such as speakers and printers.

System 1500 is connected to a network 1548 (e.g., a local area network or wide area network such as the Internet) through a network interface 1550, a modem 1552, or other suitable means for establishing communications over the network. Modem 1552, which may be internal or external, is connected to bus 1506 via serial port interface 1542.

As used herein, the terms “computer program medium,” “computer-readable medium,” and “computer-readable storage medium” are used to generally refer to memory devices or storage structures such as the hard disk associated with hard disk drive 1514, removable magnetic disk 1518, removable optical disk 1522, as well as other memory devices or storage structures such as flash memory cards, digital video disks, random access memories (RAMs), read only memories (ROM), and the like. Such computer-readable storage media are distinguished from and non-overlapping with communication media (do not include communication media or modulated data signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1532 and other program modules 1534) may be stored on the hard disk, magnetic disk, optical disk, ROM, or RAM. Such computer programs may also be received via network interface 1550, serial port interface 1542, or any other interface type. Such computer programs, when executed or loaded by an application, enable system 1500 to implement features of embodiments discussed herein. Accordingly, such computer programs represent controllers of the system 1500. Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 1500 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### IV. Further Example Embodiments

A method is described herein. The method includes: obtaining a time series of data values corresponding to a metric associated with a computing resource; detecting a seasonal pattern in the time series; performing a statistical analysis of the time series; selecting a modeler from among a plurality of different modelers based on results of the statistical analysis; utilizing the selected modeler to generate a threshold based on the seasonal pattern; monitoring the metric associated with the computing resource to determine whether the metric exceeds the threshold; and providing an indication based at least on determining that the metric exceeds the threshold.

In one implementation of the foregoing method, the plurality of different modelers comprises at least one of: a low dispersion-based modeler;
a seasonal adjusted boxplot-based modeler; or a Box-Cox transformation-based modeler.

In another implementation of the foregoing method, the selecting comprises: determining whether the data values of the time series are relatively constant or have a relatively high variance; based at least on determining that the data values of the time series are relatively constant, selecting the low dispersion-based modeler; and based at least on determining that the data values of the time series have a relatively high variance, selecting one of the seasonal adjusted boxplot-based modeler or the Box-Cox transformation-based modeler.

In another implementation of the foregoing method, said selecting one of the seasonal adjusted boxplot-based modeler or the Box-Cox transformation-based modeler comprises: determining whether the data values of the time series comprise non-positive values; based at least on determining that the data values of the time series comprise non-positive values, selecting the seasonal adjusted boxplot-based modeler; and based at least on determining that the data values of the time series do not comprise non-positive values, selecting the Box-Cox transformation-based modeler.

In another implementation of the foregoing method, the selected modeler is the seasonal adjusted boxplot-based modeler, and wherein the generating comprises: determining a plurality of bins for the seasonal pattern; for each bin of the plurality of bins: selectively assigning data values from the time series to the bin; generating a bin-based time series based on the assigned data values for the bin; and determining a bin-based threshold based on the bin-based time series; and combining each of the bin-based thresholds to generate the threshold.

In another implementation of the foregoing method, the selected modeler is the Box-Cox transformation-based modeler, and wherein the generating comprises: decomposing the seasonal pattern from the time series to obtain residual data associated with the time series; applying a Box-Cox transform to the residual data to stabilize a variance of the residual data to generate transformed residual data; determining a transformed residual data-based threshold based on the transformed residual data; applying an inverse Box-Cox transform to the transformed residual data-based threshold to reintroduce the variance, thereby generating a transformed threshold; and combining the seasonal pattern with the transformed threshold to generate the threshold.

In another implementation of the foregoing method, said detecting comprises: removing a predetermined percentage of the highest and lowest values from the time series to generate a clipped time series; filtering the time series in accordance with at least one window size to generate at least one filtered time series; filtering the clipped time series in accordance with the at least one window size to generate at least one filtered, clipped time series; and determining the seasonal pattern based on applying a respective transform to the time series, the clipped time series, a combination of the time series and the at least one filtered time series, and a combination of the clipped time series and the at least one filtered, clipped time series.

In another implementation of the foregoing method, providing the indication includes issuing an alert.

A system is also described herein. The system includes: at least one processor circuit; and at least one memory that stores program code configured to be executed by the at least one processor circuit, the program code comprising: a monitor configured to obtain a time series of data values corresponding to a metric associated with a computing resource; a seasonality detector configured to detect a seasonal pattern in the time series; and a model selector configured to: perform a statistical analysis of the time series; and select a modeler from among a plurality of different modelers based on results of the statistical analysis, the selected modeler being utilized to generate a threshold based on the seasonal pattern; the monitor further configured to monitor the metric associated with the computing resource to determine whether the metric exceeds the threshold, and providing an indication based at least on determining that the metric exceeds the threshold.

In one implementation of the foregoing system, the plurality of different modelers comprises at least one of: a low dispersion-based modeler; a seasonal adjusted boxplot-based modeler; or a Box-Cox transformation-based modeler.

In another implementation of the foregoing system, the model selector is further configured to: determine whether the data values of the time series are relatively constant or have a relatively high variance; based at least on determining that the data values of the time series are relatively constant, select the low dispersion-based modeler; and based at least on determining that the data values of the time series have a relatively high variance, select one of the seasonal adjusted boxplot-based modeler or the Box-Cox transformation-based modeler.

In another implementation of the foregoing system, the model selector is further configured to: determine whether the data values of the time series comprise non-positive values; based at least on determining that the data values of the time series comprise non-positive values, select the seasonal adjusted boxplot-based modeler; and based at least on determining that the data values of the time series do not comprise non-positive values, select the Box-Cox transformation-based modeler.

In another implementation of the foregoing system, the selected modeler is the seasonal adjusted boxplot-based modeler, and wherein the generating comprises: determining a plurality of bins for the seasonal pattern; for each bin of the plurality of bins: selectively assigning data values from the time series to the bin; generating a bin-based time series based on the assigned data values for the bin; and determining a bin-based threshold based on the bin-based time series; and combining each of the bin-based thresholds to generate the threshold.

In another implementation of the foregoing system, the selected modeler is the Box-Cox transformation-based modeler, and wherein the generating comprises: decomposing the seasonal pattern from the time series to obtain residual data associated with the time series; applying a Box-Cox transform to the residual data to stabilize a variance of the residual data to generate transformed residual data; determining a transformed residual data-based threshold based on the transformed residual data; applying an inverse Box-Cox transform to the transformed residual data-based threshold to reintroduce the variance, thereby generating a transformed threshold; and combining the seasonal pattern with the transformed threshold to generate the threshold.

In another implementation of the foregoing system, said detecting comprises: removing a predetermined percentage of the highest and lowest values from the time series to generate a clipped time series; filtering the time series in accordance with at least one window size to generate at least one filtered time series; filtering the clipped time series in accordance with the at least one window size to generate at least one filtered, clipped time series; and determining the seasonal pattern based on applying a respective transform to the time series, the clipped time series, a combination of the time series and the at least one filtered time series, and a combination of the clipped time series and the at least one filtered, clipped time series.

A computer-readable storage medium having program instructions recorded thereon that, when executed by at least one processor, perform a method. The method includes: obtaining a time series of data values corresponding to a metric associated with a computing resource; detecting a seasonal pattern in the time series; performing a statistical analysis of the time series; selecting a modeler from among a plurality of different modelers based on results of the statistical analysis; utilizing the selected modeler to generate a threshold based on the seasonal pattern; monitoring the metric associated with the computing resource to determine whether the metric exceeds the threshold; and providing an indication based at least on determining that the metric exceeds the threshold.

In another implementation of the foregoing computer-readable storage medium, the plurality of different modelers comprises at least one of: a low dispersion-based modeler; a seasonal adjusted boxplot-based modeler; or a Box-Cox transformation-based modeler.

In another implementation of the foregoing computer-readable storage medium, the selecting comprises: determining whether the data values of the time series are relatively constant or have a relatively high variance; based at least on determining that the data values of the time series are relatively constant, selecting the low dispersion-based modeler; and based at least on determining that the data values of the time series have a relatively high variance, selecting one of the seasonal adjusted boxplot-based modeler or the Box-Cox transformation-based modeler.

In another implementation of the foregoing computer-readable storage medium, said selecting one of the seasonal adjusted boxplot-based modeler or the Box-Cox transformation-based modeler comprises: determining whether the data values of the time series comprise non-positive values; in response to determining that the data values of the time series comprise non-positive values, selecting the seasonal adjusted boxplot-based modeler; and in response to determining that the data values of the time series do not comprise non-positive values, selecting the Box-Cox transformation-based modeler.

In another implementation of the foregoing computer-readable storage medium, the selected modeler is the seasonal adjusted boxplot-based modeler, and wherein the generating comprises: determining a plurality of bins for the seasonal pattern; for each bin of the plurality of bins: selectively assigning data values from the time series to the bin; generating a bin-based time series based on the assigned data values for the bin; and determining a bin-based threshold based on the bin-based time series; and combining each of the bin-based thresholds to generate the threshold.

In another implementation of the foregoing computer-readable storage medium, the selected modeler is the Box-Cox transformation-based modeler, and wherein the generating comprises: decomposing the seasonal pattern from the time series to obtain residual data associated with the time series; applying a Box-Cox transform to the residual data to stabilize a variance of the residual data to generate transformed residual data; determining a transformed residual data-based threshold based on the transformed residual data; applying an inverse Box-Cox transform to the transformed residual data-based threshold to reintroduce the variance, thereby generating a transformed threshold; and combining the seasonal pattern with the transformed threshold to generate the threshold.

### V. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosure should not be limited by any of the above-described example embodiments, but should be defined only in accordance with the following claims and their equivalents.

What is claimed is:

1. A method, comprising:
obtaining a time series of data values corresponding to a metric associated with a computing resource;
detecting a seasonal pattern in the time series;
performing a statistical analysis of the time series;
selecting a modeler from among a plurality of different modelers based on results of the statistical analysis;
utilizing the selected modeler to generate a threshold based on the seasonal pattern;
monitoring the metric associated with the computing resource to determine whether the metric exceeds the threshold; and
providing an indication based at least on determining that the metric exceeds the threshold.

2. The method of claim 1, wherein the plurality of different modelers comprises at least one of:
a low dispersion-based modeler;
a seasonal adjusted boxplot-based modeler; or
a Box-Cox transformation-based modeler.

3. The method of claim 2, wherein the selecting comprises:
determining whether the data values of the time series are relatively constant or have a relatively high variance;
based at least on determining that the data values of the time series are relatively constant, selecting the low dispersion-based modeler; and
based at least on determining that the data values of the time series have a relatively high variance, selecting one of the seasonal adjusted boxplot-based modeler or the Box-Cox transformation-based modeler.

4. The method of claim 3, wherein said selecting one of the seasonal adjusted boxplot-based modeler or the Box-Cox transformation-based modeler comprises:
determining whether the data values of the time series comprise non-positive values;
based at least on determining that the data values of the time series comprise non-positive values, selecting the seasonal adjusted boxplot-based modeler; and
based at least on determining that the data values of the time series do not comprise non-positive values, selecting the Box-Cox transformation-based modeler.

5. The method of claim 2, wherein the selected modeler is the seasonal adjusted boxplot-based modeler, and wherein the generating comprises:
determining a plurality of bins for the seasonal pattern;
for each bin of the plurality of bins:
selectively assigning data values from the time series to the bin;
generating a bin-based time series based on the assigned data values for the bin; and
determining a bin-based threshold based on the bin-based time series; and
combining each of the bin-based thresholds to generate the threshold.

6. The method of claim 2, wherein the selected modeler is the Box-Cox transformation-based modeler, and wherein the generating comprises:
decomposing the seasonal pattern from the time series to obtain residual data associated with the time series;
applying a Box-Cox transform to the residual data to stabilize a variance of the residual data to generate transformed residual data;
determining a transformed residual data-based threshold based on the transformed residual data;
applying an inverse Box-Cox transform to the transformed residual data-based threshold to reintroduce the variance, thereby generating a transformed threshold; and
combining the seasonal pattern with the transformed threshold to generate the threshold.

7. The method of claim 1, wherein said detecting comprises:
removing a predetermined percentage of the highest and lowest values from the time series to generate a clipped time series;
filtering the time series in accordance with at least one window size to generate at least one filtered time series;
filtering the clipped time series in accordance with the at least one window size to generate at least one filtered, clipped time series; and
determining the seasonal pattern based on applying a respective transform to the time series, the clipped time series, a combination of the time series and the at least one filtered time series, and a combination of the clipped time series and the at least one filtered, clipped time series.

8. The method of claim 1, wherein providing the indication includes issuing an alert.

9. A system, comprising:
at least one processor circuit; and
at least one memory that stores program code configured to be executed by the at least one processor circuit, the program code comprising:
a monitor configured to obtain a time series of data values corresponding to a metric associated with a computing resource;
a seasonality detector configured to detect a seasonal pattern in the time series; and
a model selector configured to:
perform a statistical analysis of the time series; and
select a modeler from among a plurality of different modelers based on results of the statistical analysis, the selected modeler being utilized to generate a threshold based on the seasonal pattern;
the monitor further configured to monitor the metric associated with the computing resource to determine whether the metric exceeds the threshold, and
providing an indication based at least on determining that the metric exceeds the threshold.

10. The system of claim 9, wherein the plurality of different modelers comprises at least one of:
a low dispersion-based modeler;
a seasonal adjusted boxplot-based modeler; or
a Box-Cox transformation-based modeler.

11. The system of claim 9, wherein the model selector is further configured to:
determine whether the data values of the time series are relatively constant or have a relatively high variance;
based at least on determining that the data values of the time series are relatively constant, select the low dispersion-based modeler; and
based at least on determining that the data values of the time series have a relatively high variance, select one of the seasonal adjusted boxplot-based modeler or the Box-Cox transformation-based modeler.

12. The system of claim 11, wherein the model selector is further configured to:
determine whether the data values of the time series comprise non-positive values;
based at least on determining that the data values of the time series comprise non-positive values, select the seasonal adjusted boxplot-based modeler; and
based at least on determining that the data values of the time series do not comprise non-positive values, select the Box-Cox transformation-based modeler.

13. The system of claim 10, wherein the selected modeler is the seasonal adjusted boxplot-based modeler, and wherein the seasonal adjusted boxplot-based modeler is utilized to generate the threshold by:
determining a plurality of bins for the seasonal pattern;
for each bin of the plurality of bins:
selectively assigning data values from the time series to the bin;
generating a bin-based time series based on the assigned data values for the bin; and
determining a bin-based threshold based on the bin-based time series; and
combining each of the bin-based thresholds to generate the threshold.

14. The system of claim 10, wherein the selected modeler is the Box-Cox transformation-based modeler, and wherein the Box-Cox transformation-based modeler is utilized to generate the threshold by:
decomposing the seasonal pattern from the time series to obtain residual data associated with the time series;
applying a Box-Cox transform to the residual data to stabilize a variance of the residual data to generate transformed residual data;
determining a transformed residual data-based threshold based on the transformed residual data;
applying an inverse Box-Cox transform to the transformed residual data-based threshold to reintroduce the variance, thereby generating a transformed threshold; and
combining the seasonal pattern with the transformed threshold to generate the threshold.

15. The system of claim 9, wherein the seasonality detector is further configured to:
remove a predetermined percentage of the highest and lowest values from the time series to generate a clipped time series;
filter the time series in accordance with at least one window size to generate at least one filtered time series;
filter the clipped time series in accordance with the at least one window size to generate at least one filtered, clipped time series; and
determine the seasonal pattern based on applying a respective transform to the time series, the clipped time series, a combination of the time series and the at least one filtered time series, and a combination of the clipped time series and the at least one filtered, clipped time series.

16. A computer-readable storage medium having program instructions recorded thereon that, when executed by at least one processor, perform a method, the method comprising:
obtaining a time series of data values corresponding to a metric associated with a computing resource;
detecting a seasonal pattern in the time series;
performing a statistical analysis of the time series;
selecting a modeler from among a plurality of different modelers based on results of the statistical analysis;
utilizing the selected modeler to generate a threshold based on the seasonal pattern;
monitoring the metric associated with the computing resource to determine whether the metric exceeds the threshold; and
providing an indication based at least on determining that the metric exceeds the threshold.

17. The computer-readable storage medium of claim 16, wherein the plurality of different modelers comprises at least one of:
a low dispersion-based modeler;
a seasonal adjusted boxplot-based modeler; or
a Box-Cox transformation-based modeler.

18. The computer-readable storage medium of claim 17, wherein the selecting comprises:
determining whether the data values of the time series are relatively constant or have a relatively high variance;
based at least on determining that the data values of the time series are relatively constant, selecting the low dispersion-based modeler; and
based at least on determining that the data values of the time series have a relatively high variance, selecting one of the seasonal adjusted boxplot-based modeler or the Box-Cox transformation-based modeler.

19. The computer-readable storage medium of claim 18, wherein said selecting one of the seasonal adjusted boxplot-based modeler or the Box-Cox transformation-based modeler comprises:
determining whether the data values of the time series comprise non-positive values;
based at least on determining that the data values of the time series comprise non-positive values, selecting the seasonal adjusted boxplot-based modeler; and
based at least on determining that the data values of the time series do not comprise non-positive values, selecting the Box-Cox transformation-based modeler.

20. The computer-readable storage medium of claim 17, wherein the selected modeler is the seasonal adjusted boxplot-based modeler, and wherein the generating comprises:
determining a plurality of bins for the seasonal pattern;
for each bin of the plurality of bins:
selectively assigning data values from the time series to the bin;
generating a bin-based time series based on the assigned data values for the bin; and
determining a bin-based threshold based on the bin-based time series; and
combining each of the bin-based thresholds to generate the threshold.
